(19) United States
(12) Patent Application Publication
(10) Pub. No.: US 2011/0099816 A1
(43) Pub. Date: May 5, 2011

(54) ELECTRIC TRIMMER WITH FLIP COVER

(76) Inventor: VITO JAMES CARLUCCI, Stratford, CT (US)

(21) Appl. No.: 12/609,592

(22) Filed: Oct. 30, 2009

(51) Int. Cl. B26B 19/38

(52) U.S. Cl. 30/47

(57) ABSTRACT

An electric trimmer has a trimmer portion, a flip cover and a blade mechanism within the trimmer portion. A switch operates upon movement of the flip cover to activate the blade mechanism.

### FIELD OF THE INVENTION

The present invention relates to electric trimmers. More particularly, the invention relates to a flip cover, battery-operated trimmer suitable for carrying from place-to-place.

### BACKGROUND OF THE INVENTION

Known electric trimmers, be they battery-operated or electric powered, are not generally suitable for on-the-go use. Electric powered trimmers are generally limited for use near a wall socket, whereas battery-operated trimmers are not ideal for general in-pocket carrying because they tend to be large and cumbersome to carry.

One solution has already been proposed in U.S. Pat. No. 6,782,625 to Wong (“the '625 patent”), which describes an electric shaver having a casing with a lid and a shaving mechanism housed within the casing. The shaving mechanism includes a shaving head and is mounted so as to protrude from the casing when the lid is opened. Thus, the shaving mechanism is movable from a storage position to a use position where the shaving head protrudes from the casing. A switch operates upon movement of the shaving mechanism to activate the shaving mechanism.

A disadvantage of the invention disclosed in the '625 patent is the movement of the shaving mechanism from the storage position to the use position.

It is an object of the present invention to overcome or substantially ameliorate the at least one disadvantage stated above and more generally to provide a flip cover electric trimmer for use on-the-go.

It is a further object of the present invention to provide an electric trimmer having a flip cover to protect the blade mechanism of the trimmer when not in use.

It is a further object of the present invention to provide an electric trimmer having a switch actuated by the flip cover to activate the trimmer.

### SUMMARY OF THE INVENTION

There is disclosed herein an electric trimmer comprising a flip cover, a trimmer portion, a blade assembly in the trimmer portion, and a switch operated by opening the flip cover to activate the mechanism.

Preferably a hinge attaches the flip cover to the trimmer portion and a spring or detent keeps the flip cover either in the closed position or open position for use. Preferably the spring biases the flip cover to a closed position.

Other features and advantages of the invention will be clear from the following description of preferred embodiments of the invention. It is to be understood that the foregoing general description and the following detailed description are exemplary and explanatory but are not to be restrictive of the invention. The accompanying drawings, which are incorporated in and constitute a part of this invention, illustrate embodiments of the invention and, together with the description, serve to explain the principles of the invention in general terms. Like numerals refer to like parts throughout the disclosure.

### BRIEF DESCRIPTION OF THE INVENTION

The foregoing aspects and other features of the present invention are explained in the following description, taken in connection with the accompanying drawings, wherein:

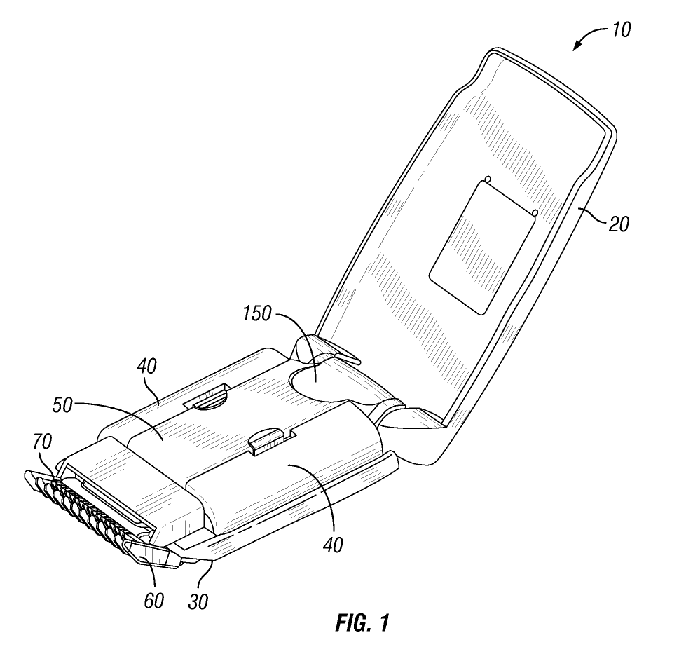

FIG. 1 is a perspective drawing of the electric trimmer of the present invention in an opened position;

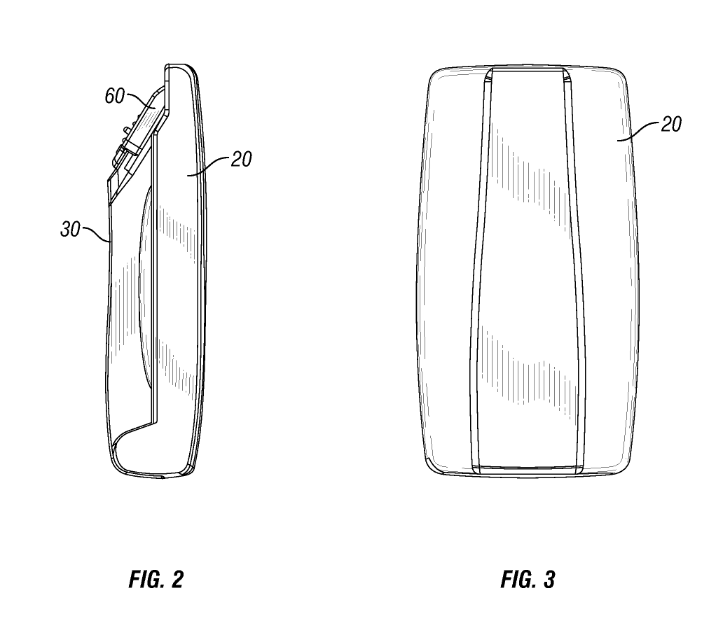

FIG. 2 is a side view of the electric trimmer of the present invention in a closed position as depicted in FIG. 3;

FIG. 3 is a front view of the electric trimmer of the present invention in a closed position;

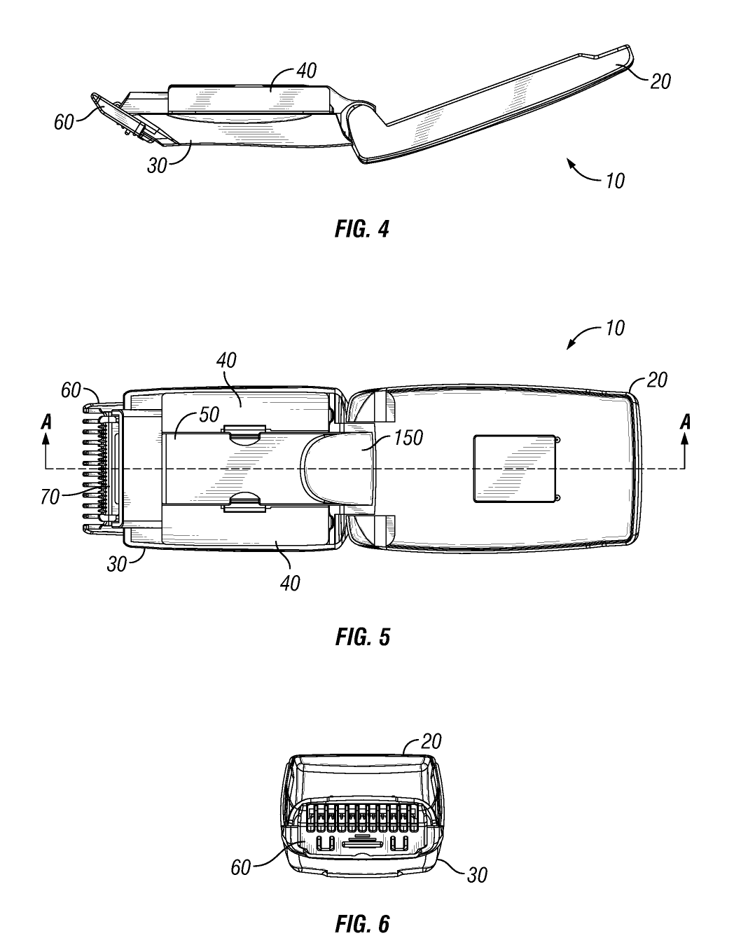

FIG. 4 is a side view of the electric trimmer of the present invention in an opened position;

FIG. 5 is a top view of the electric trimmer depicted in FIG. 4;

FIG. 6 is a side view of the electric trimmer depicted in FIG. 4;

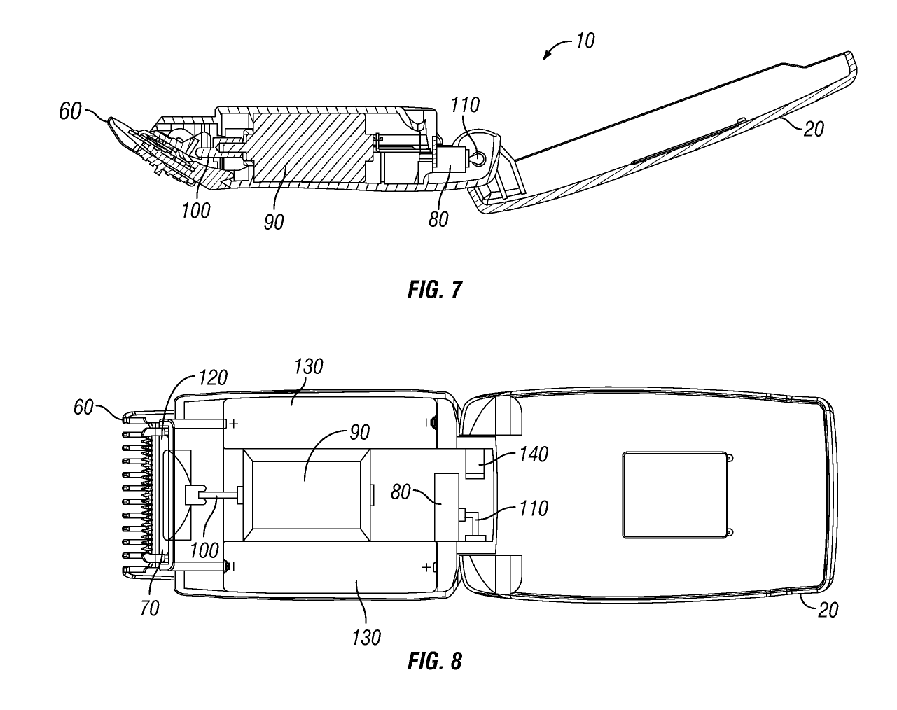

FIG. 7 is a cross section view along line A-A of FIG. 5; and

FIG. 8 is a top view of the electric trimmer depicted in FIG. 4.

### DETAILED DESCRIPTION OF THE INVENTION

Reference will now be made in detail to embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, left, and right may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

Referring to the drawings, FIG. 1 in particular, electric trimmer 10 comprises a flip cover 20 attached hingedly to a trimmer portion 30. A spring or detent 140 (see FIG. 8) keeps flip cover 20 in either a closed position (see FIGS. 2 and 3) or an opened position (FIGS. 1 and 4-8) as required. Trimmer 10 would be typically fabricated from steel, stainless steel, brass, silver, gold, plastics or any other appealing material. FIG. 1 depicts trimmer 10 in an opened position, i.e., with flip cover 20 opened, whereas FIGS. 2 and 3 depict trimmer 10 in a closed position, i.e., with flip cover 20 closed.

Trimmer portion 30 comprises blade assembly 70 to which guide comb 60 is removably attached. As shown more clearly in FIG. 8, trimmer portion 30 further comprises two battery compartments 130 and motor 90, which connects with blade assembly 70 via output shaft 100 of motor 90. Output shaft 100 may be in the form of an eccentric wheel. The preferred embodiment, as shown, provides battery compartments 130 on each side of trimmer 10, allowing for motor 90 to be placed thereinbetween permitting trimmer 10 to be compact and slim.

Blade assembly 70 may be a reciprocating blade assembly, a rotary blade assembly or any other blade assembly known in the art for cutting or trimming of hair. Blade assembly 70 preferably has a moveable reciprocating blade 120 in slidable contact with a stationary blade (not shown). Reciprocating blade 120 and the stationary blade may have teeth, as generally shown in the figures, or may have a razor edge or any other acceptable cutter or other means to cut hair positioned between the reciprocating and stationary blades. A movable guide comb 60 may slidably connect in various positions to blade assembly 70 as known in the art.

Power to motor 90 is supplied by batteries (not shown) or any other suitable power supply known in the art. The batteries are retained in battery compartments 130. Switch 80 controls the delivery of power from the power supply to motor 90, and is actuated by actuator 110 of flip cover 20. When flip cover 20 is in a closed position (see FIGS. 2 and 3), switch 80 is not activated by actuator 110 and no power is delivered to motor 90. On the other hand, when flip cover 20 is in an opened position (see, e.g., FIG. 1), switch 80 is activated by actuator 110 and power is delivered to motor 90.

As shown in FIG. 5, trimmer portion 30 includes battery covers 40 to help retain the batteries in place and motor cover 50 to protect motor 90 and blade assembly 70. Battery covers 40 may include a locking device or tab to enable removal of the covers 40 for replacement of the batteries.

In use, a user simply flips open flip cover 20 by moving it against initial resistance provided by spring or detent 140. Continued movement of flip cover 20 causes it to pass a threshold point, whereupon the force of spring or detent 140 causes flip cover 20 to the opened position depicted in FIG. 1. At this stage, actuator 110 actuates switch 80 and power is delivered from the batteries to motor 90 causing operation of blade assembly 70. A recess 150 is used to locate the user's thumb for added stability during use of trimmer 10.

Upon completion of use of electric trimmer 10, the user simply closes flip cover 20 to deactivate switch 80, thus cutting off power to motor 90. In a closed position, flip cover 20 preferably provides protection to blade assembly 70 and guide comb 60.

It should be appreciated that modifications and alterations obvious to those skilled in the art are not to be considered as beyond the scope of the present invention. For example, the specific switching and biasing arrangements depicted in the drawings may be substituted with equivalent devices. Accordingly, the present invention is intended to embrace all such alternatives, modifications and variances which fall within the scope of the appended claims.

What is claimed is:

1. An electric trimmer comprising:
a trimmer portion;
a flip cover hingedly attached to the trimmer portion;
the trimmer portion comprising a blade assembly and a switch;
the flip cover comprising an actuator, wherein opening the flip cover causes the actuator to activate the switch to activate the blade assembly.

2. The electric trimmer of claim 1 further including a spring biasing the flip cover in a closed position.

3. The electric trimmer of claim 1 further including a spring biasing the flip cover in an opened position.

4. The electric trimmer of claim 1 further comprising a guide comb slidably mounted on the blade assembly.

5. The electric trimmer of claim 4, wherein the flip cover protects the guide comb and the blade assembly.

6. The electric trimmer of claim 1 further comprising a recess to locate a user's thumb for added stability during use of the electric trimmer.

7. The electric trimmer of claim 1 further including a spring biasing the flip cover in an opened position.
